(19) United States
(12) Patent Application Publication
(10) Pub. No.: US 2010/0059942 A1
(43) Pub. Date: Mar. 11, 2010

(54) SEALING DISC WITH AN OXYGEN ABSORBING SUBSTANCE

(75) Inventor: Peter Rothweiler, Freden an der Leine (DE)

Correspondence Address: SALTER & MICHAELSON;THE HERITAGE BUILDING, 321 SOUTH MAIN STREET, PROVIDENCE, RI, 029037128, US

(73) Assignee: ALFELDER KUNSTSTOFFWERKE HERM. MEYER GMBH, Alfeld/Leine (DE)

(21) Appl. No.: 12/306,074

(22) PCT Filed: Jun. 20, 2007
(86) PCT No.: PCT/EP2007/056141

§ 371 Date: Sep. 15, 2009

(30) Foreign Application Priority Data
Jun. 28, 2006 (DE) 10 2006 030 074.2

(51) Int. Cl. F16J 15/10; F16J 15/12

(52) U.S. Cl. 277/654

(57) ABSTRACT

The invention relates to a sealing disk for openings of containers, comprising a metal layer used to inject heat by induction, a layer which can be sealed on the container opening and which can be melted by thermal conduction via the metal layer. The sealable layer is adjacent to the inside of the container when the sealing disk is placed on the container opening. An absorber layer which can extract and/or absorb oxygen from the fluid is provided such that said absorber layer is in contact with the inside of the container when the sealing disk is placed on the container opening.

The invention relates to a sealing disc for container openings of containers with an oxygen-absorbing substance.

Sealing discs are known in a wide variety of forms. They serve to seal the mouths of containers. For example, foodstuffs in solid, liquid or powdered consistency are located in the containers, and it is undesirable, on the one hand, for these container contents to discharge from the container and, on the other hand, it is also undesirable for foreign substances or also ambient air to enter the container and come into contact with the filling material in the container. Therefore, the cover is closed to the top with screw closures, cam turning closures, plug closures or the like, while the container mouth itself is sealed with a tightly seated sealing disc that seals the container mouth. Whereas the external closure cap above all serves for mechanical closure and also for re-closure of a container once opened, but is not generally completely tight, the sealing disc is configured so that it forms a hermetically sealed closure. In general, the sealing disc is placed on the container mouth together with the closure cap after the contents have be placed in the container. The consumer then opens the closure cap, and as a result, depending on the embodiment, the sealing disc is either opened or must additionally be pulled off or pierced by the consumer.

Attempts have been made occasionally to provide the sealing discs with additional desirable properties. For instance, many foodstuffs develop oxygen in containers during the course of storage and discharge this into the region above the foodstuff, which is also referred to as the headroom. This oxygen is also partly formed during the filling operation or is enclosed in certain amounts in the container interior together with the substances during filling. Further oxygen can enter the headroom, for example, in the case of containers made of polyethylene terephthalate (PET).

This oxygen is undesirable in many cases, since it adversely affects the storage capability and/or taste or other properties of the filling material, e.g. also the optical appearance of the filling material, i.e. even when only present in relatively small quantities inside the container.

For this reason, in patent EP 0 803 445 B1 of the applicant, for example, a sealing disc, in particular for bottle closures, is proposed for containers, which are or are to be filled with a filling material, which has substances that react with oxygen, e.g. beverages such as wine for instance. This sealing disc prevents the gaseous component of the alcohol contained in the alcoholic drink or wine, for example, from passing through the sealing disc to the outside, while also reducing the entry of oxygen and the formation of oxygen in the bottle interior. For this purpose, a substance is provided as layer on the side of the sealing disc to be directed towards the container content that absorbs oxygen and thus removes this oxygen from the headroom above the filling material.

Patent EP 1 007 427 B1 also describes a multilayered sealing disc with oxygen-absorbing properties, wherein a multilayered arrangement is provided comprising gas-permeable or gas-impermeable layers of polymer material including foam layers respectively arranged one on top of the other.

A sealing disc is known from patent EP 1 462 381 B1, which has an aluminium layer and a layer of polyethylene foam, which are connected to one another by means of an adhesive layer. An oxygen-absorbing layer between two layers of polyethylene is also a possibility.

While these proposals from the prior art have been used highly successfully and certainly serve to extend the life of filling materials in containers, there are still demands for a further optimisation of the possibilities of sealing discs. Thus, the known sealing discs can only be used with certain types of closure, i.e. in particular with those, in which the sealing discs are inserted into a screw or cam turning closure. They can then actually also serve their desired purpose of use during transport and the subsequent storage period and are then generally removed when the container is opened. However, this proven form of attachment of loosely placed discs in the case of sealing discs or container closures is not desirable or does not meet requirements in all cases.

Therefore, it is an object of the invention to propose a sealing disc, which has oxygen-absorbing properties, but can also be fixed to the container neck.

This object is achieved by a sealing disc for container openings of containers, with an electrically conductive layer suitable for introducing heat by induction, with a layer, which can be melted on by heat conduction from the electrically conductive layer and can be sealed on the container opening, wherein the sealable layer is adjacent to the container interior of the container when the sealing disc is placed on the container opening, and with an absorber layer, which can remove and/or absorb oxygen from a filling material located in the container interior, wherein the absorber layer connects with the container interior when the sealing disc is placed on the container opening.

The range of use is significantly expanded with such a sealing disc. An inductively sealable sealing insert is obtained that has the property to absorb oxygen from the headroom of a container.

This is usable and useful in particular with filling materials the properties of which are negatively influenced upon contact with oxygen, e.g. by oxidation such as in the case of unpreserved fruit and vegetable juices or also in the case of beer.

In the case of an inductive sealing, heat is induced into a sealing disc by induction, e.g. by generating swirling currents. A specific part of the sealing disc, into which this heat can be induced dissipates this by heat conduction to its adjacent layers and causes a partial melting of these layers as well as the adjacent mouth edge of the container. This results in a very strong connection between the partially melted underside of the sealing disc in the region of the container edge with the actual upper rim of this container edge.

This very strong connection through sealing not only leads to a particularly tight seal of the container mouth, but additionally also to an originality protection. Such a sealed sealing disc cannot be re-sealed by manipulation after its initial opening, so that a consumer can always easily ascertain at a glance whether a container has already been opened before he would like to open it for the first time.

Sealing is readily possible with glass containers and is also widely used therewith, and moreover additionally provides the advantage with plastic containers, for example, that a strong connection precisely of the sealing layer with a plastic edge of a container mouth is possible.

This inductive sealing of the closures of plastic containers is already used in another context, and therefore appropriate technical installations exist for conducting the inductive sealing. The inductive sealing is used as a means for providing originality protection and as a reliable barrier for protection against external influences, e.g. as an oxygen and water vapour barrier.

Oxygen-absorbing sealing inserts from the prior art have generally been non-inductively sealable hitherto, since their properties excluded this. The oxygen-absorbing substance should likewise be directed towards the container interior, like the layers for induction sealing, which at first glance is mutually exclusive. Patent EP 1 462 381 B1 has therefore already tried a solution in another direction.

It is all the more surprising that these mutually supplementary advantages are nevertheless achievable in one and the same sealing disc. The sealing disc according to the invention is not only inductively sealable, but also has an oxygen-absorbing function.

For the invention there are basically three different embodiments that lead to the same result and provide different additional advantages, depending on the application case and external boundary conditions.

In a first embodiment it is preferred if the sealing disc is configured so that the layer sealable on the container mouth has sections, which absorb oxygen, and/or that the layer has oxygen-removing and/or absorbing properties. This means that the sealable layer and the absorber layer are basically one and the same layer.

This is a surprising concept, since it had actually been assumed that these two very special properties are mutually exclusive. However, it has been found through tests that it is possible to maintain the sealing properties required above all at the edge of the container mouth or container opening and at the same time provide this layer with absorbing properties, which are above all required in the central region of the sealing disc, i.e. where there is contact over a particularly large area with the headroom of the container interior.

In a second embodiment it is preferred if starting from the container opening, the sealing disc has, one on top of the other, the sealable layer, on top of that the electrically conductive layer suitable for introducing heat by induction, and on top of that the absorber layer absorbing oxygen from a filling material located in the container interior, wherein perforations, which lead to the absorber layer, are directed through the sealable layer and the electrically conductive layer.

This concept has special advantages in that the chemical composition of all the layers is unchanged from conventional sealing discs, although in an unusual novel structure. The electrically conductive layer introducing heat from induction into the sealing disc is covered on one side by a sealable layer. These two layers are then perforated, i.e. provided either with one or also with a plurality of perforation holes. Then an absorber layer is placed on the other side of the metal layer. If this sealing disc is now placed on the container mouth with the sealable layer facing downwards, then the sealing process can naturally be conducted in an orderly manner as in the conventional process. However, because of the perforations any oxygen present in the headroom of the container interior can now pass through the two lower layers of the sealing disc and enter the region of the absorber layer. The absorber layer can thus also fulfil its function.

The electrically conductive layer will preferably be a metal layer. An aluminium layer in particular will be used in practice, since a particularly effective introduction can occur here and also aluminium is relatively light, and therefore the weight of the complete fastening is not substantially increased and finally is also relatively inexpensive to purchase.

This concept is also of particular interest, because even the composite comprising the aluminium layer with the sealable layer remains unchanged from the conventional proven layer composites of this type except, of course, for the perforations provided for this purpose.

The absorber layer here is preferably covered to the top by an oxygen barrier layer. Since the absorber layer is now the uppermost layer, it could come into contact with the ambient air, which would cause its ability to absorb oxygen to quickly disappear, which is undesirable in many cases.

In a third embodiment it is preferred if beginning at the container opening, the sealing disc firstly has the layer sealable on the container opening, then an oxygen-absorbing and/or removing absorber layer and on top of this the metal layer suitable for coupling heat by induction arranged one on top of the other, and the layer sealable on the container opening is permeable to the fluid in the container interior and/or to oxygen.

In this embodiment the effect is now advantageously used that the sealing layer can also be altered so that it is impermeable to foreign bodies or also to water, for example, but permeable to oxygen. Then as a result of the permeability to oxygen, this can penetrate through the sealable layer and into the next layer, which is the absorber layer in this embodiment. Thus, the absorber layer can also fulfil its function here.

Combinations of different embodiments are also conceivable. For example, one of these is such that the sealable layer has a content of oxygen-absorbing material or of constituents corresponding to increasing space contents that increases from its side directed towards the content of the container to the side remote from the container and adjoining the electrically conductive layer.

It is also possible to configure this sealable layer from two layers, which respectively have a specific proportion of oxygen-absorbing material.

The proportion of oxygen-absorbing material or of sections with oxygen-absorbing properties lies adjacent to the container opening, for example, with a proportion of between 0% and 3%, in particular about 1%. This proportion can then rise continuously in one or a plurality of stages to 5% to 20%, a range of about 10% being preferred.

The resulting sealing layers form films, which are firmly sealed or peelable (removable), depending on demand and practical requirements. There can be used designs with outwardly projecting tabs or in particular also with protruding folds or with layer regions which lie loose for, and therefore can be gripped by, the user.

Sodium sulphite can be used, for example, as material for the oxygen-absorbing and/or oxygen-removing layers and regions. Sodium sulphite is activated at an air humidity of 90% and more and then begins to absorb the oxygen and thus remove it from the surrounding area.

An alternative to sodium sulphite is also an iron-containing material, e.g. iron powder. Iron powder oxidises itself and removes oxygen from its surrounding area, which is then absent there. However, during this oxidation the iron powder itself becomes brownish. Therefore, such an absorber material is largely used in circumstances that are not optically demanding.

Further absorber materials can be used that are not activated by a specific air humidity, but by the use of ultraviolet light, for example. Completely different oxygen-absorbing or oxygen-removing substances are also conceivable.

One embodiment has sodium sulphite in the sealing layer in a proportion of about 10% that increases towards the interior of the sealing insert to a proportion of up to 33%.

Three exemplary embodiments of the invention will be explained in more detail below on the basis of the drawings:

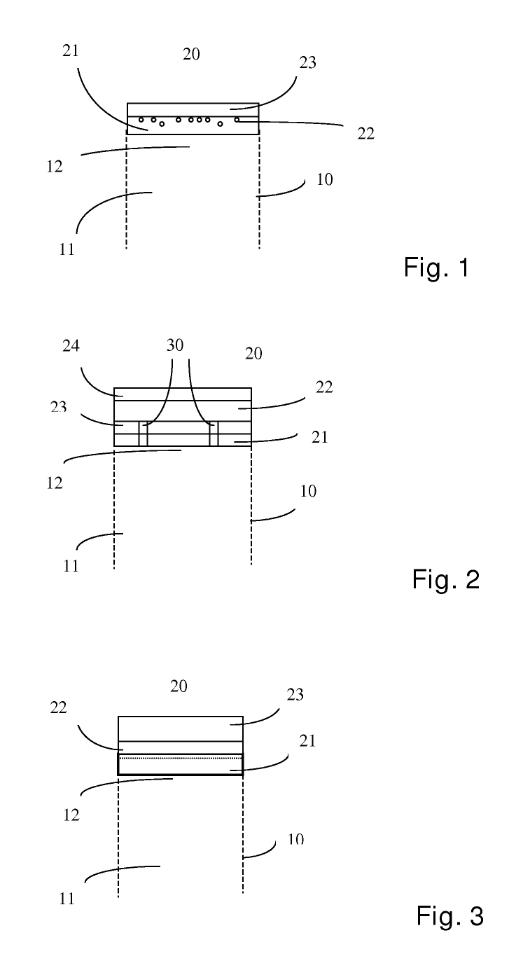

FIG. 1 shows a section through a first embodiment of a sealing disc according to the invention on a container;

FIG. 2 shows a section through a second embodiment of a sealing disc according to the invention on a container; and

FIG. 3 shows a section through a third embodiment of a sealing disc according to the invention on a container.

The container 10 has an interior 11, in which filling material is located or into which filling material can be introduced. The container 10 has a cylindrical container mouth, and in specific embodiments this can also have a square, polygonal, oval or other cross-section.

Only the container mouth 12 of the container 10 is shown schematically in all the Figures. The container mouth 12 is plane at the top in each case, so that a sealing disc given the overall reference 20 can be placed flat thereon.

The sealing disc 20 is configured differently in each case in the different embodiments in FIGS. 1 to 3, wherein, however, the individual components resemble one another or generate similar effects and fulfil similar functions, and are therefore provided with corresponding reference numerals.

The sealing disc 20 has a plurality of functionalities distributed on different regions of the sealing disc 20. As first, there is a sealable layer 21, also referred to as the sealing layer 21, which has a meltable material that can form an integral bond with the container mouth 12. As second, a layer 22 with oxygen-absorbing properties is provided, which is also referred to as the absorber layer 22. Finally as third, a metal layer 23 is provided, which is generally an aluminium layer 23, into which energy that is converted into heat in this aluminium layer 23 can be injected by means of magnetic induction from an external electromagnetic field.

In the embodiment of FIG. 1, a multilayered structure of the sealing disc 20 may be seen such that the bottom layer adjacent to the container mouth 12 is a layer 21, which at the same time has oxygen-absorbing properties. For this, the sealing layer 21 must be specially mixed in order to additionally obtain the oxygen-absorbing properties, which are indicated by the addition of small circular sections with the reference numeral 22.

This does not mean that specific sections of the sealing layer 21 have been removed and filled with different material of an absorber layer 22, although this would also be a possibility in this embodiment. However, a variant is preferred, in which oxygen-absorbing materials are integrated into the sealing layer 21, i.e. in such a quantity that the sealing properties of this sealing layer 21 on the container mouth 12 are not impaired.

An aluminium layer 23 is provided as further layer above this sealing layer 21 with the properties of absorber layer 22. This aluminium layer 23 serves as heat conductor. Heat can then be introduced into this aluminium layer 23 from the outside by induction, and is then transferred to the sealing layer 21 by heat conduction and causes this to partially melt in the region of the peripheral edge adjacent to the container mouth 12, as a result of which a locking seal occurs there.

An additional barrier layer (not shown) can also be provided between the sealing layer 21 and the aluminium layer 23 that serves to protect the aluminium against corrosion as a result of any aggressive filling materials possibly present in the container interior 11.

Further layers (likewise not shown) of polyethylene and/or polypropylene foam can additionally be provided above the aluminium layer 23 that serve as thermal buffers and to compensate mouth tolerances.

A PET layer can then be provided above this layer for protection against sealing on the base of the closure cap.

In the embodiment in FIG. 2 a sealing layer 21 directed towards the container 10 or the container interior 11 and the container mouth 12 is also located as bottom layer of the sealing disc 20. In this case, the sealing layer 21 does not have to have oxygen-absorbing properties.

An aluminium layer 23 for the inductive supply of heat for the partial melting of the sealing layer 21 is also located above the sealing layer 21 here.

An absorber layer 22 is located above the aluminium layer 23 here.

Both the sealing layer 21 and the aluminium layer 23 are provided with one or more or in particular a multiplicity of perforations 30, which pass through both layers. These perforations 30 are provided so that they do not impair the sealing properties in the region of the peripheral edge of the container mouth 12. This can be assured by not extending the perforations 30 into the edge region of the sealing disc 20.

A continuous absorber layer 22 is located above the aluminium layer 23. When the sealing disc 20 is in attached state on the container mouth 12, this absorber layer 22 connects with the container interior 11 and the filling materials located therein by means of the perforations 30. This means that the absorber layer 23 can perform its oxygen-absorbing function in spite of the aluminium layer 23 and sealing layer 21 located inbetween.

An oxygen barrier layer 24 is additionally provided above the absorber layer 22 in this embodiment. This oxygen barrier layer 24 screens the absorber layer 22 from the oxygen located outside the sealing disc 20 or outside the container 10. It must be additionally taken into consideration that the absorber layer 22 should also be protected from oxygen entering from the side. Since the representations are not true to scale, however, it should be noted that this region occupies a much smaller section of area than the upwardly directed closure region of the absorber layer 22.

Further layers can then be provided above the oxygen barrier layer 24 as in the embodiments of FIG. 1.

In the embodiment according to FIG. 3, a sealing layer 21 is again located adjacent to the container mouth 12 as bottom layer of the sealing disc 20. This also has no oxygen-absorbing or oxygen-removing properties of its own here.

However, it is oxygen-permeable. This is likewise not provided in conventional sealing layers, but can be achieved by appropriate novel mixtures.

In this embodiment, an absorber layer 22 is located above the sealing layer 21 that is joined over its full surface here.

An aluminium layer 23 that serves to inductively supply heat is again located above the absorber layer 22. Here, the aluminium layer 23 dissipates the absorbed heat by means of heat conduction processes through the absorber layer 22 to the sealing layer 21 at least in the region of the periphery of the container mouth 12, and again allows the sealing layer 21 to be sealed on the container mouth 12 there.

No perforations are provided in this embodiment. However, since the sealing layer 21 is oxygen-permeable here, oxygen can enter the absorber layer 22 through the sealing layer 21, so that the absorber layer 22 can also fulfil its function here.

Further layers above the aluminium layer 23 are also conceivable and possible here as in the two other embodiments.

All three embodiments can be used both for so-called single-part sealing discs, which do not have an element remaining in the closure for sealing, and for so-called two-part sealing discs, which do have an element remaining in the closure for sealing.

The second case concerns so-called “resealing elements”. For this, a carton or a carton with PET or polyethylene foam with lamination or a polypropylene foam with lamination is used that is connected to the layers of the sealing disc 20 shown in FIG. 1, 2 or 3 by means of a separable connection layer of wax or polyolefin. This re-sealing element is therefore connected to the uppermost of the layers shown by means of a connection layer, but is separated from this when the closure cap is opened for the first time and remains in the closure cap. The consumer then removes the components of the sealing disc 20 remaining on the container mouth 12 and shown in FIGS. 1 to 3, and can then close the container 10 again, as desired, with the closure cap and the upper components of the sealing disc 20 remaining in the closure cap. Thus, the filling materials in the container interior 11 of the container 10 can be kept at least for a temporary period.

### LIST OF REFERENCE NUMERALS

10 container
11 container interior
12 container mouth or container opening
20 sealing disc
21 sealable layer, also sealing layer
22 layer or region that can remove or absorb oxygen from a fluid, also absorber layer
23 metal layer suitable for introducing heat by induction, generally an aluminium layer
24 oxygen barrier layer
30 perforation

1. Sealing disc for container openings of container, comprising:
an electrically conductive layer suitable for introducing heat by induction,
a sealable layer, which can be melted on by heat conduction from the electrically conductive layer and can be sealed on the container opening,
wherein the sealable layer is adjacent to the container interior of the container when the sealing disc is placed on the container opening, and
an absorber layer which can remove and/or absorb oxygen from a filling material located in the container interior
wherein the absorber layer connects with the container interior when the sealing disc is placed on the container opening.

2. Sealing disc according to claim 1, characterised in that starting from the container opening the sealing disc has, one on top of the other, the sealable layer,
on top of that the electrically conductive layer suitable for introducing heat by induction, and
on top of that the absorber layer absorbing oxygen from a filling material located in the container interior,
wherein perforations, which lead to the absorber layer, are directed through the sealable layer and the electrically conductive layer.

3. Sealing disc according to claim 2, characterised in that the oxygen-removing absorber layer is covered to the top by an oxygen barrier layer.

4. Sealing disc according to claim 1, characterised in that the sealable layer sealable on the container opening has oxygen-absorbing sections and/or oxygen-removing and/or absorbing properties, so that the sealable layer and the absorber layer are one and the same layer.

5. Sealing disc according to claim 4, characterised in that starting from the container mouth, the sealable layer sealable on the container opening has a continuously or discontinuously increasing proportion of oxygen-absorbing sections and/or proportion having oxygen-absorbing properties.

6. Sealing disc according to claim 5, characterised in that the proportion of the oxygen-absorbing sections and/or the material components having oxygen-absorbing properties increases from a proportion amounting to between 0% and 3% to a proportion amounting to between 5% and 20%.

7. Sealing disc according to claim 1, characterised in that starting from the container opening, the sealing disc firstly has the sealable layer sealable on the container opening, then an oxygen-absorbing and/or removing absorber layer and
on top of this the electrically conductive layer suitable for introducing heat by induction, and
that the sealable layer sealable on the container opening is permeable to the fluid in the container interior and/or to oxygen.

8. Sealing disc according to claim 1, characterised in that the electrically conductive layer suitable for introducing heat by induction is a metal layer.

9. Sealing disc according to claim 8, characterised in that the metal layer is an aluminum layer.

10. Sealing disc according to claim 1, characterised in that sodium sulphite, an iron-containing material or a material which can be activated by ultraviolet light, is used as the oxygen-removing or -absorbing substance.

11. Sealing disc according to claim 8, characterised in that starting from the container opening the sealing disc has, one on top of the other, the sealable layer,
on top of that the electrically conductive layer suitable for introducing heat by induction, and
on top of that the absorber layer absorbing oxygen from a filling material located in the container interior,
wherein perforations, which lead to the absorber layer, are directed through the sealable layer and the electrically conductive layer.

12. Sealing disc according to claim 8, characterised in that the oxygen-removing absorber layer is covered to the top by an oxygen barrier layer.

13. Sealing disc according to claim 8, characterised in that the sealable layer sealable on the container opening has oxygen-absorbing sections and/or oxygen-removing and/or absorbing properties, so that the sealable layer and the absorber layer are one and the same layer.

14. Sealing disc according to claim 8, characterised in that starting from the container mouth, the sealable layer sealable on the container opening has a continuously or discontinuously increasing proportion of oxygen-absorbing sections and/or proportion having oxygen-absorbing properties.

15. Sealing disc according to claim 8, characterised in that the proportion of the oxygen-absorbing sections and/or the material components having oxygen-absorbing properties increases from a proportion amounting to between 0% and 3% to a proportion amounting to between 5% and 20%.

16. Sealing disc according to claim 1, characterised in that starting from the container opening, the sealing disc firstly has the sealable layer sealable on the container opening, then an oxygen-absorbing and/or removing absorber layer and
on top of this the electrically conductive layer suitable for introducing heat by induction, and
that the sealable layer sealable on the container opening is permeable to the fluid in the container interior and/or to oxygen.

17. Sealing disc according to claim 10, characterised in that starting from the container opening the sealing disc has, one on top of the other, the sealable layer,
on top of that the electrically conductive layer suitable for introducing heat by induction, and
on top of that the absorber layer absorbing oxygen from a filling material located in the container interior,
wherein perforations, which lead to the absorber layer, are directed through the sealable layer and the electrically conductive layer.

18. Sealing disc according to claim 10, characterised in that the sealable layer sealable on the container opening has oxygen-absorbing sections and/or oxygen-removing and/or absorbing properties, so that the sealable layer and the absorber layer are one and the same layer.

19. Sealing disc according to claim 10, characterised in that starting from the container mouth, the sealable layer sealable on the container opening has a continuously or discontinuously increasing proportion of oxygen-absorbing sections and/or proportion having oxygen-absorbing properties.

20. Sealing disc according to claim 1, characterised in that starting from the container opening, the sealing disc firstly has the sealable layer sealable on the container opening, then an oxygen-absorbing and/or removing absorber layer and
on top of this the electrically conductive layer suitable for introducing heat by induction, and
that the sealable layer sealable on the container opening is permeable to the fluid in the container interior and/or to oxygen.
